(19) United States
(12) Patent Application Publication
(10) Pub. No.: US 2014/0369072 A1
(43) Pub. Date: Dec. 18, 2014

(54) Transparent Display Apparatus

(71) Applicant: AU Optronics Corporation, Hsin-Chu (TW)

(72) Inventors: Yi-Yang Liao, Hsin-Chu (TW); Chia-Wei Kuo, Hsin-Chu (TW); Bo-Shiang Tseng, Hsin-Chu (TW); Ching-Huan Lin, Hsin-Chu (TW)

(73) Assignee: AU Optronics Corporation, Hsin-Chu (TW)

(21) Appl. No.: 14/254,411

(22) Filed: Apr. 16, 2014

(30) Foreign Application Priority Data
Jun. 18, 2013 (TW) 102121587

(51) Int. Cl. G02F 1/1335; F21V 11/00; F21V 8/00

(52) U.S. Cl. CPC G02F 1/133602; G02B 6/0068; F21V 11/00
USPC 362/613; 362/97.1

(57) ABSTRACT

A transparent display apparatus is provided. The display apparatus includes a plurality of white sub-pixels and a plurality of color sub-pixels that are mixedly arranged. The display apparatus also includes a control module for controlling the white sub-pixels and the color sub-pixels. When the display apparatus is in a transparent mode, the control module reduces or stops light emitting from the color sub-pixels and allows at least a part of ambient light behind the white sub-pixels to emit from the white sub-pixels to achieve the see-through effect. When the display apparatus is in a display mode, the control module adjusts at least one of the white or color sub-pixels to ensure that light from the white sub-pixels is far less than light from the color sub-pixels.

### BACKGROUND OF THE INVENTION

1. Field of the Invention

The present invention generally relates to a display apparatus. Particularly, the present invention relates to a transparent display apparatus.

2. Description of the Prior Art

In recent years, flat display devices have been widely used in a variety of fields as an independent display device or embedded in electronic devices for displaying information. There are all kinds of flat display devices including, for example, organic light-emitting diode display device, liquid crystal display device, electrophoretic display device, etc. Among them, liquid crystal display device is the most common flat display device.

For conventional liquid crystal display (LCD) device, since a backlight module is disposed on the backside, the LCD device is not transparent and cannot be seen through, and thus the background behind the LCD device cannot be seen. Other types of flat display devices are in similar situation. However, in a certain circumstance, such as head-up display on the windshield or description display on the cabinet, there is a need to see the background behind the display device during or not during the image display. Consequently, conventional LCD devices cannot satisfy such needs.

### SUMMARY OF THE INVENTION

It is an object of the present invention to provide a display apparatus having transparent effect.

It is another object of the present invention to provide a display apparatus, which can selectively switch between a transparent mode and a display mode.

The display apparatus includes a plurality of white sub-pixels and a plurality of color sub-pixels that are mixedly arranged. At least a part of the white sub-pixels is partially or fully transparent or can be seen through. Each pixel can generate light in a self-lighting or passive lighting manner and can be combined to form the image generated by the display apparatus. The display apparatus further includes a control module to control the white sub-pixels and the color sub-pixels. The display apparatus can be selectively set at a transparent mode or a display mode. When the display apparatus is set at the transparent mode, the control module reduces or stops light emitting from the color sub-pixels and also allows at least a part of ambient light behind the white sub-pixels (with respect to the display direction) to emit from the white sub-pixels to achieve the see-through effect. When the display apparatus is set at the display mode, the control module will adjust at least one of the white sub-pixels and the color sub-pixels, so that the light generated from the white sub-pixels is far less than light generated from the color sub-pixels to display image.

### BRIEF DESCRIPTION OF THE DRAWINGS

FIG. 1 is a schematic views of a display apparatus;

FIG. 2A is a schematic view of a display apparatus switched to the transparent mode;

FIG. 2B is a schematic view of a display apparatus switched to the display mode;

FIG. 3A is a schematic view of a side-lighting liquid crystal display apparatus;

FIG. 3B is a schematic view of a variant embodiment of FIG. 3A;

FIG. 4A is a schematic view of the embodiment of FIG. 3A switched to the transparent mode;

FIG. 4B is a schematic view of the embodiment of FIG. 3A switched to the display mode;

FIG. 5 is a schematic view of an embodiment of a direct type liquid crystal display device;

FIG. 6A is a schematic view of the embodiment of FIG. 5 switched to the transparent mode;

FIG. 6B is a schematic view of the embodiment of FIG. 5 switched to the display mode;

FIG. 7A and FIG. 7B are schematic views of the embodiment of FIG. 3A incorporated with a switchable diffusion film;

FIG. 8 is a schematic view of an embodiment of an organic light-emitting diode display device;

FIG. 9A and FIG. 9B are schematic views of different pixel arrangements; and

FIG. 10 is a schematic view of another embodiment of the pixel arrangement.

### DETAILED DESCRIPTION OF THE PREFERRED EMBODIMENT

The present invention provides a transparent display apparatus. In preferred embodiments, the display apparatus can include an LCD device, an organic light emitting diode display device, or other types of display devices. LCD devices preferably can include a backlight module with side lighting light source or direct lighting light source, both being applicable to implement the technical features of the present invention.

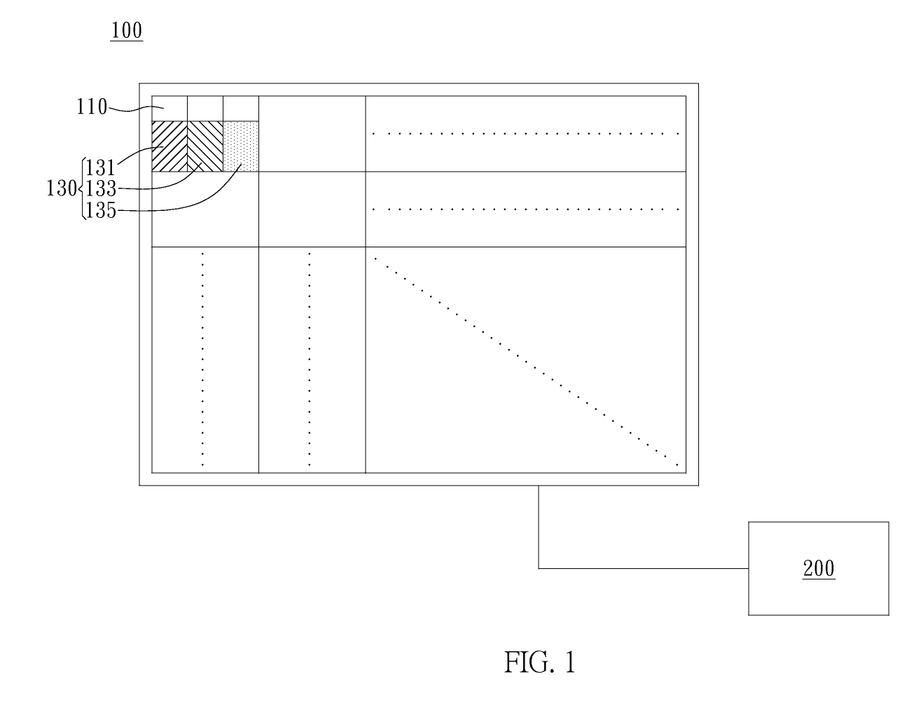

As shown in FIG. 1, the display apparatus 100 includes a plurality of white sub-pixels 110 and a plurality of color sub-pixels 130 that are mixedly arranged. At least part of the white sub-pixels 110 can be partially or fully transparent or can be seen through. In a preferred embodiment, the color sub-pixels 130 can include color pixels of different colors, such as red sub-pixels 131, green sub-pixels 133, and blue sub-pixels 135. The combination of one white sub-pixel 110 with one red sub-pixel 131, one green sub-pixel 133, and one blue sub-pixel 135 can form one pixel. Each pixel can generate light in a self-lighting or passive lighting manner and be combined to form the image generated by the display apparatus 100. In the embodiment, the display apparatus 100 can be a self-lighting display device, such as organic light-emitting diode (OLED) display device, or a non-self-lighting display device, such as LCD device. For OLED display device, each pixel includes a layered structure of lower and upper substrates as well as the organic light-emitting layer disposed therebetween within a divided area. For LCD device, each pixel includes a layered structure of a display panel including liquid crystal layer, a backlight module, and any possible layer within a divided area. More particularly, in the foresaid LCD device, each pixel generates light in a passive manner, referring that each pixel generates light by means of the backlight module and is controlled, in cooperation with the twist of liquid crystal molecules in each pixel and the disposition of polarizers, to allow the light to pass therethrough, so that the image display effect is achieved on the display panel.

In addition, the display apparatus 100 further includes a control module 200 that controls the white sub-pixels 110 and the color sub-pixels 130. For different types of display apparatus 100, the control of the white sub-pixels 110 and the color sub-pixels 130 by the control module 200 is different. For example, for LCD device, the control of the white sub-pixels 110 and the color sub-pixels 130 by the control module 200 includes the control of the twist of liquid crystal molecules and/or the backlight source. For OLED display device, the control of the white sub-pixels 110 and the color sub-pixels 130 by the control module 200 includes the control of voltage of the organic light-emitting layer.

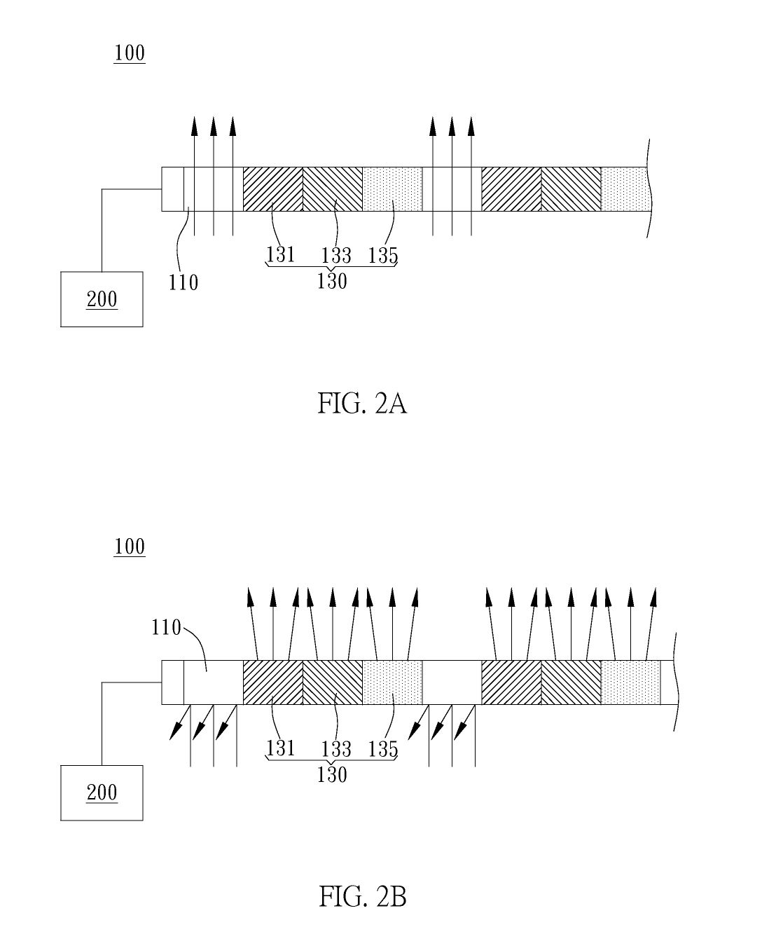

In a preferred embodiment, the display apparatus 100 can be selectively set at a transparent mode or a display mode. When the display apparatus 100 is set at the transparent mode, as shown in FIG. 2A, the control module 200 controls to reduce or stop light emitting from the color sub-pixels 130 and allows ambient light behind the white sub-pixels 110 (i.e. the rear side with respect to the display direction) to pass through the white sub-pixels 110. As described above, the way that the control module 200 controls the color sub-pixels 130 to reduce light generated therefrom can be varied according to the type of display apparatus 100. For example, the control module 200 can control the twist of liquid crystal molecules to block the light, reduce the brightness of the backlight source, or reduce the light intensity of the organic light-emitting diode layer. Moreover, the white sub-pixels 110 allow the ambient light to pass therethrough because of the transparency characteristics. However, the control module 200 can control the twist of liquid crystal molecules to increase the amount of ambient light that passes through the white sub-pixels 110.

When the display apparatus 100 is set at the display mode, as shown in FIG. 2B, the control module 200 will adjust at least one of the white sub-pixels 110 and the color sub-pixels 130, so that one of the white sub-pixels 110 has a first brightness less than a second brightness of the color sub-pixels 130. For LCD device, the control module 200 can selectively or simultaneously control the twist of liquid crystal molecules or control the brightness of backlight to increase the brightness of the color sub-pixels 130, and the control module 200 also can reduce the brightness of the white sub-pixels 110 in same or different way. For OLED display device, the control module 200 can selectively or simultaneously increase the brightness of the organic light-emitting layer of the color sub-pixels 130 and reduce the brightness of the light-emitting layer of the white sub-pixels 110. Of course, there can be no organic light-emitting layer disposed in the white sub-pixels 110 at all. When the white sub-pixels 110 has a small amount or even no light generated by self-lighting light source, partial light generated by the color sub-pixels 130 may emit from the white sub-pixels 110. However, the partial light emitting from the white sub-pixels 110 is far less than the light generated by the color sub-pixels 130.

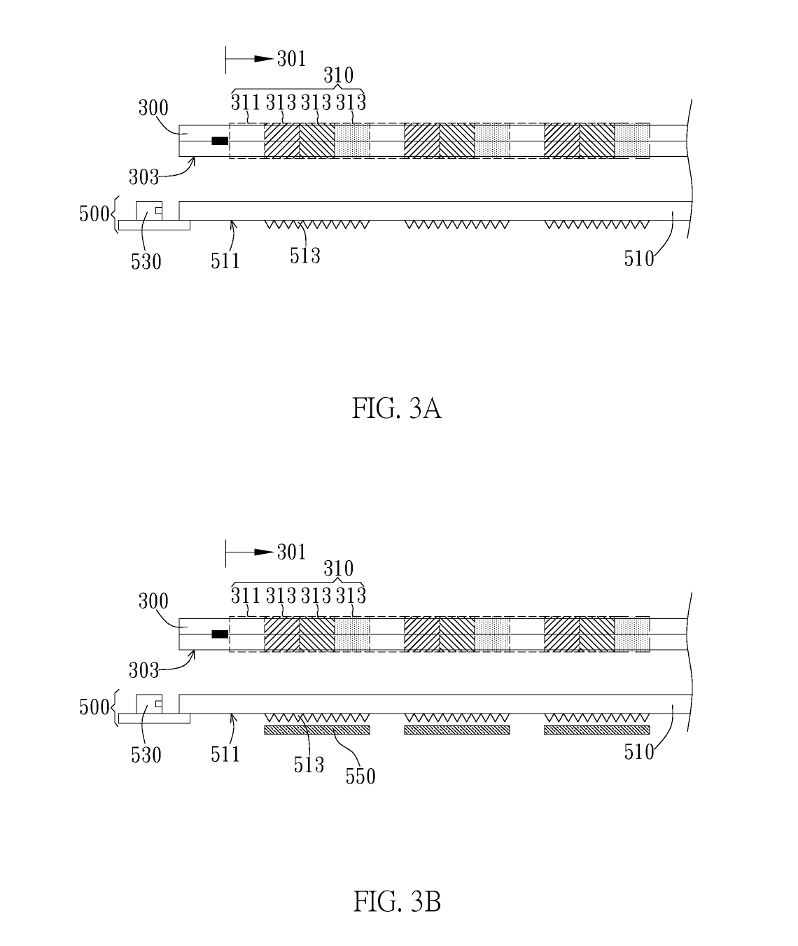

FIG. 3A is a schematic view of an embodiment of the display apparatus in form of a LCD device. As shown in FIG. 3A, the display apparatus includes a display panel 300 and a light source module 500. In this embodiment, the display panel 300 is a panel including a liquid crystal layer, and a display area 301 thereof is divided into a plurality of pixels 310. Each pixel 310 consists of a plurality of color sub-pixels 313 of different colors and at least one white sub-pixel 311. In other words, the color sub-pixels 313 and the white sub-pixels 311 are mixedly arranged within the display area 301. The light source module 500 is disposed or formed on the backside of the display area 301. For example, the light source module 500 can be disposed on the inner side of the back surface 303 of the display panel 300 or the outer side of the back surface 303. In this embodiment, the light source module 500 is a backlight module for LCD device and disposed on the outer side of the back surface 303 of the display panel 300. The light source module 500 generates light that passes through the display panel 300 for displaying image on the display area 301.

In a preferred embodiment, light generated by the light source module 500 at the position corresponding to the white sub-pixels 311 is less than light generated at the position corresponding to the color sub-pixels 313. In the embodiment of FIG. 3A, the light source module 500 is a side lighting backlight module including a light guide plate 510 and a side lighting light source 530. The light guide plate 500 is disposed on the outer side of the back surface 303 of the display panel 300 and is formed with a plurality of light-output microstructures 513 on a bottom face 511 that is away from the display panel 300. In a preferred embodiment, the light-output microstructures 513 are disposed only at locations outside a projection area of the white sub-pixels 311 on the bottom face 511. The side-lighting light source 530 is disposed corresponding to the side edge of the light guide plate 510 and generates light into the light guide plate 510. The light into the light guide plate 510 will be transmitted within the light guide plate 510 and emit from the top face of the light guide plate 510 when in contact with the light-output microstructures 513 on the bottom face 511. Since no light-output microstructure is disposed within the projection area of the white sub-pixels 311 on the bottom face 511, the light transmitted within the light guide plate 511 does not readily emit from the area within the projection area of the white sub-pixels 311. Even if there is light of larger emitting angle entering the area within the projection area of the white sub-pixels 311, the amount thereof is far less than the amount of light emitting from the area within the projection area of the color sub-pixels 313.

With such a design, since the light guide plate 510 is made of light-transparent or transparent material, when no light-output microstructure 513 is disposed within the projection area of the white sub-pixels 311, the light behind the light guide plate 510 will transmit through the light source module 500 without being overly diffused or twisted and emit from the display panel 300. In other words, the background view behind the display apparatus can be seen from the display side of the display panel 300 to create the see-through effect. As shown in FIG. 3B, if the light source module 500 has a reflective plate 550 disposed on the backside of the light guide plate 510, the reflective plate 550 preferably has through holes or is formed transparent at locations corresponding to the projection area of the white sub-pixels 311 so as to allow the backside ambient light to pass therethrough.

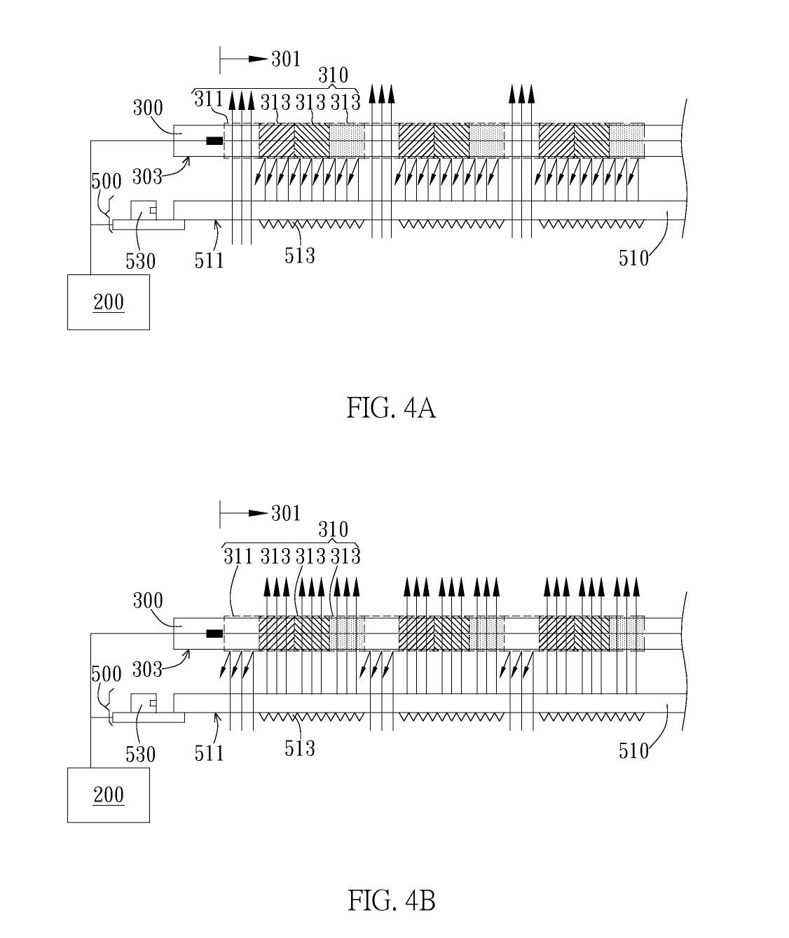

As shown in FIG. 4A, as an LCD device, the display apparatus further includes a control module 200 that controls the display panel 300 and the light source module 500. When the display apparatus is set at the transparent mode, the control module 200 controls the white sub-pixels 311 allowing the ambient light from the backside with respect to the display panel 300 to transmit therethrough and simultaneously controls the color sub-pixels 313 reducing the light generated therefrom. Specifically, in this embodiment, the control module 200 can control the twist of liquid crystal molecules in the white sub-pixels 311 in cooperation with the disposition of polarizers to allow the light from the backside to transmit therethrough. In addition, there are different ways that the control module 200 controls the color sub-pixels 130 to reduce light generated therefrom. For example, the control module 200 can turn off the light source module 500 so that no light will be generated or can control the twist of liquid crystal molecules, in cooperation with the polarizers, to block the light. Of course, the methods described above can be implemented in combination or alone to achieve the effect of the present invention.

As shown in FIG. 4B, when the display apparatus is set at the display mode, after the backlight passes through the display area, the white sub-pixels 311 has a first brightness value and the color sub-pixels has a second brightness value. The control module 200 controls the white sub-pixels 311 reducing the first brightness value and simultaneously controls the color sub-pixels 313 increasing the second brightness value, wherein the first brightness value is preferably smaller than the second brightness value. Specifically, in this embodiment, the control module 200 can control the twist of liquid crystal molecules in the white sub-pixels 311, in cooperation with the disposition of polarizers, blocking or partially blocking the backside light to transmit therethrough. There are several ways that the control module 200 controls the color sub-pixels 130 to increase light generated therefrom. For example, the control module 200 can turn on the light source module 500 so that light will be generated or can control the twist of liquid crystal molecules, in cooperation with the polarizers, allowing the light to pass therethrough so as to achieve the image display effect on the display area 301.

Furthermore, the display apparatus can be set at a different mode, such as local transparent and display mode. When the display apparatus is set at the local transparent and display mode, a portion of the display area 301 is operated at the transparent mode and another portion of the display area 301 is operated at the display mode. Such a local transparent and display mode can be achieved by utilizing the control module 200 to respectively control different white sub-pixels 311 and color sub-pixels 313 and selectively by cooperating with the local lighting technique of the light source module 500. When the display apparatus is set at the local transparent and display mode, the control module 200 adopts a part of the settings for transparent mode and a part of the settings for display mode to achieve the effect of displaying image and simultaneously seeing-through the background behind the display apparatus. For example, the control module 200 can control the twist of liquid crystal molecules in the white sub-pixels 311, in cooperation with the disposition of polarizer, to allow the ambient light from behind to pass through and simultaneously activate the light source module 500 to emit light, in cooperation with the twist of liquid crystal molecules in the color sub-pixels 313 and the disposition of polarizer, to allow the light pass through to display images.

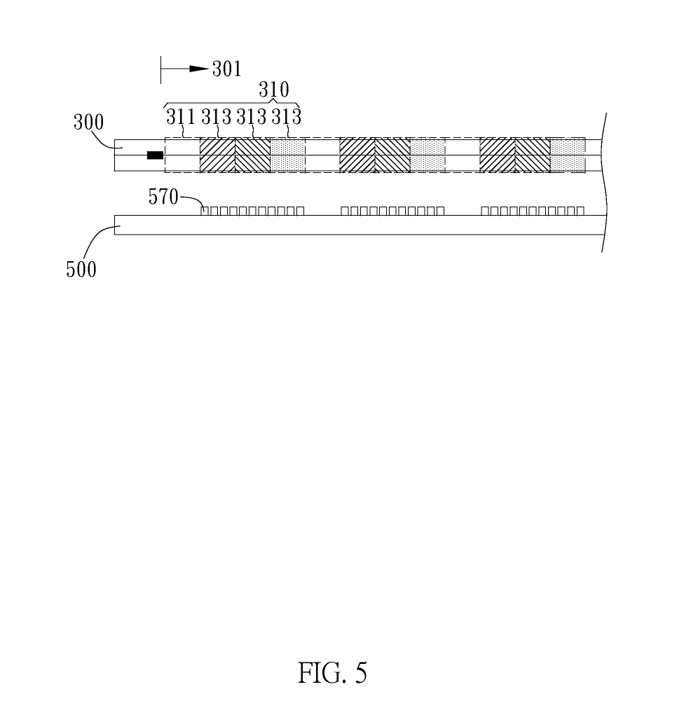

FIG. 5 illustrates a schematic view of a direct type liquid crystal display device. As shown in FIG. 5, the light source module 500 includes a plurality of direct-lighting light sources 570, which are disposed to face the backside of the display panel 300 and generate light into the display area 301. The direct-lighting light sources 570 are disposed within the projection of the display area 301, preferably at locations outside the projection area of the white sub-pixels 311 and more preferably at locations corresponding to the color sub-pixels 313. The direct-lighting light sources 570 are preferably crystal light-emitting diodes (crystal LEDs) or other light sources having smaller volume so as to correspond the disposition positions of the color sub-pixels 313. In addition, the direct-lighting light sources 570 preferably has a lighting field angle less than 120 degrees to reduce the possibility that large angle light enters the region of white sub-pixels the 311. Since no direct-lighting light source 570 is disposed at locations corresponding to the white sub-pixels 311, no large amount of light will be generated within the region of the white sub-pixels 311. Even if large angle light from the region corresponding to the color sub-pixels 313 enters the region of white sub-pixels 311, the amount of light will be far less than the light emitted from the color sub-pixels 313.

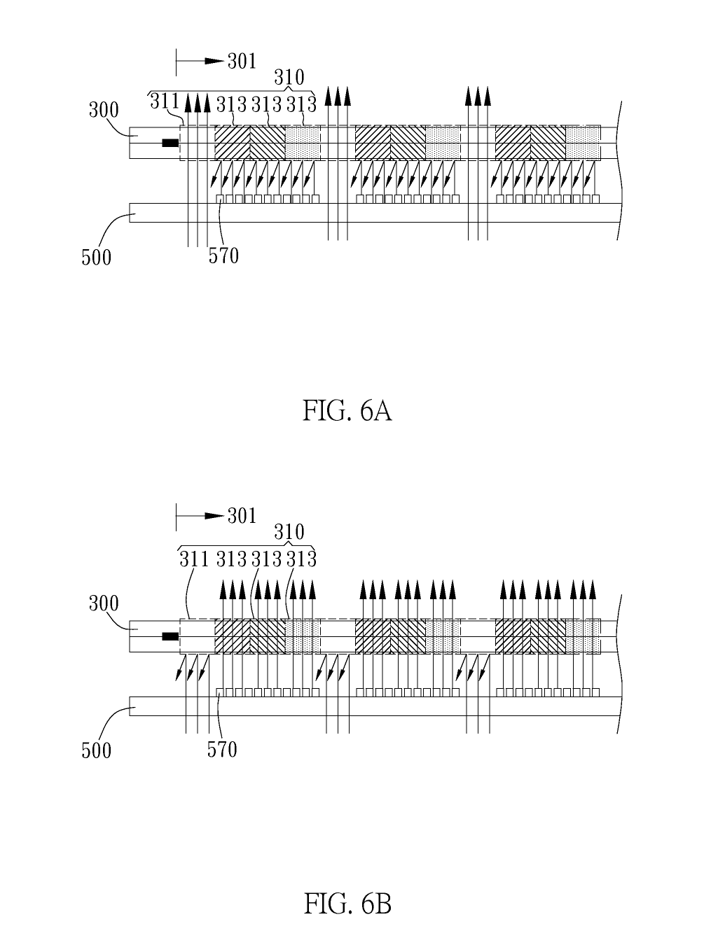

As shown in FIGS. 6A and 6B, as a direct type backlight LCD device, the display apparatus further includes a control module 200 that controls the display panel 300 and a light source module 500. In comparison with the edge type backlight LCD device, when the display apparatus is switched between the transparent mode shown in FIG. 6A, the display mode shown in FIG. 6B, or other applications, the control module 200 of this embodiment can control ON/OFF status of direct-lighting light sources 570 more freely and precisely, thus having a stronger manipulation ability. Moreover, since the light source module 500 does not have a light guide plate, the transmission rate of the ambient light from behind can be promoted at the transparent mode to enhance luminance.

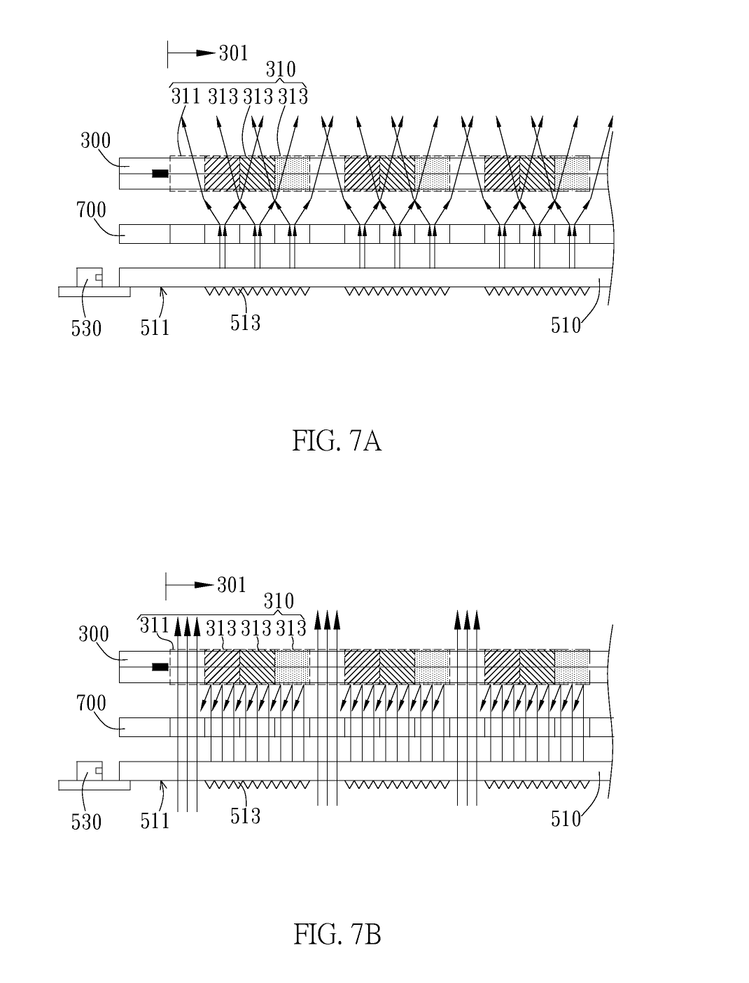

In the embodiment of FIGS. 7A and 7B, the display apparatus further includes a switchable diffusion film 700 disposed between the display panel 300 and the light source module 500. The switchable diffusion film 700 is selectively switched between a diffusion mode and a transmission mode by preferably controlling the liquid crystal molecule layer with voltage. When the switchable diffusion film 700 is switched to the diffusion mode, as shown in FIG. 7A, the liquid crystal molecule layer is preferably controlled in a random arrangement so that light passing therethrough will be scattered. When the switchable diffusion film 700 is switched to the transmission mode, the liquid crystal molecule layer is preferably controlled in an alignment arrangement so that light passing therethrough will not change the traveling direction. When the display apparatus is set at the transparent mode, as shown in FIG. 7B, a portion of the switchable diffusion film 700 corresponding to the white sub-pixels 311 is preferably set at the transmission mode to reduce light-scattering, allowing the ambient light from behind to pass through. When the display apparatus is set at the display mode, another portion of the switchable diffusion film 700 corresponding to the color sub-pixels 313 is preferably set at the diffusion mode to provide diffusion effect as the backlight passing through so as to achieve a more uniform backlight. The switch of the switchable diffusion film 700 between the transmission mode and the diffusion mode can be employed in a general switch manner to the entire film or in a local switch manner to respective pixels. For the general switch manner, the circuit design is relatively less complicated and easy to achieve. For the local switch manner, the display apparatus will have higher design flexibility and a variety of operation modes, such as transparent mode, display mode, local transparent and display mode, etc.

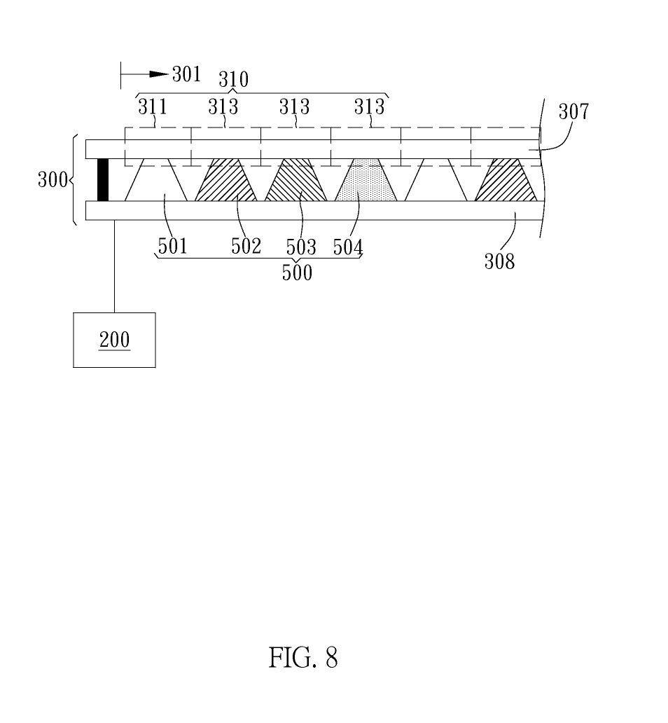

FIG. 8 illustrates an organic light-emitting diode display device as an example of the display apparatus. As shown in FIG. 8, the display apparatus similarly includes a display panel 300 and a light source module 500. In this embodiment, the display area 301 of the display panel 300 can be divided into a plurality of pixels 310, and each pixel 310 consists of a plurality of color sub-pixels 313 of different colors and at least one white sub-pixel 311. In other words, a plurality of color sub-pixels 313 and the white sub-pixels 311 are mixedly arranged within the display area 301. Similarly, the light source module 500 is disposed on the backside of the display area 301. Different from the embodiment of the liquid crystal display device described above, the light source module 500 is disposed or formed on the inner side of the upper substrate 307 or the lower substrate 308 of the display panel 300. In this embodiment, the light source module 500 is self-lighting organic light-emitting layers 501, 502, 503, 504. In response to sub-pixels including white sub-pixels 311 and color sub-pixels 313, organic light-emitting layers 501, 502, 503, 504 of different colors can be disposed to actively generate light into the display area 301 for image display.

In a preferred embodiment, light generated by the light source module 500 at the position corresponding to the white sub-pixels 311 is less than light generated at the position corresponding to the color sub-pixels. In the embodiment of FIG. 8, the light source module 500 at the position corresponding to the white sub-pixels 311 can be formed as more transparent, thinner, or less amount of organic light-emitting diode layer 501 or even can be formed without the organic light-emitting layer, so as to provide sufficient transparency at such positions. When the display apparatus is set at the transparent mode, the control module 200 controls the organic light-emitting layers 502, 503 of the light source module 500 that corresponds to the color sub-pixels 313 not to generate light. Meanwhile, since the organic light-emitting layer 501 that corresponds to the white sub-pixels 311 has the transparency property, the background view behind the display apparatus can be seen from the display side of the display apparatus 300 to achieve the see-through effect.

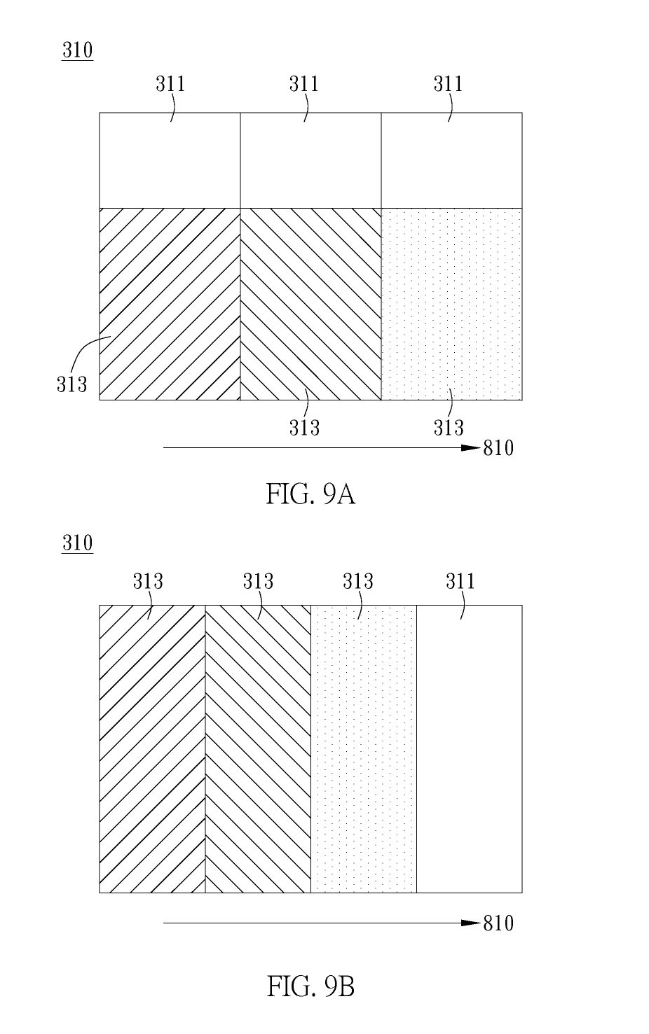

FIG. 9A is a schematic view of an embodiment of the arrangement of the pixels 310 of the display area 301. In this embodiment, in a same pixel 310, the white sub-pixels 311 are disposed on the same side of the color sub-pixels 313. Specifically, as shown in FIG. 9A, in a same pixel 310, the amount of the color sub-pixels 313 is the same as that of the white sub-pixels 311. The color sub-pixels 313 of different colors are disposed along the first direction 810, and the white sub-pixels 311 are also disposed along the first direction 810 and arranged on one side of the color sub-pixels 313 parallel to the first direction 810. In other words, the color sub-pixels 313 and the white sub-pixels 311 are disposed side by side in two rows along the first direction 810. In this embodiment, since each color sub-pixel 313 has one white sub-pixel 311 on its one side, the light leaking from the color sub-pixel 313 to the white sub-pixel 311 will become more uniform without favoring a specific color. However, in other embodiments, as shown in FIG. 9B, in a same pixel 310, the white sub-pixel 311 is also disposed on the same side of the color sub-pixels 313, but the white sub-pixel 311 is arranged with the color-sub-pixels 313 along the first direction 810. In this embodiment, since only one white sub-pixel 311 is disposed in each pixel 310, the design of driving circuit is less complicated.

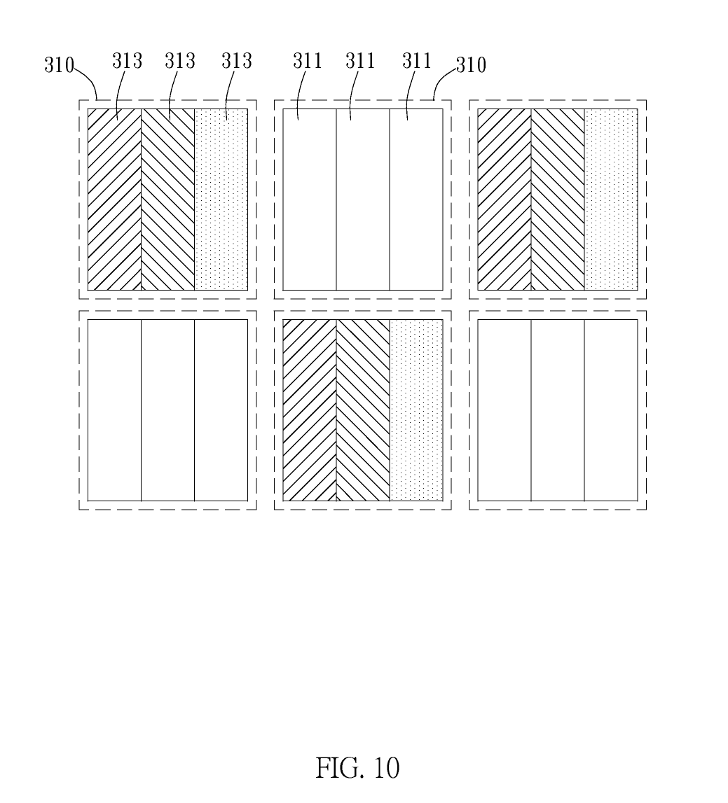

FIG. 10 is a schematic view of another embodiment of the arrangement of the pixels 310. The pixels 310 can consist of a plurality of color sub-pixels 313 of different colors or a plurality of white sub-pixels 311, and the pixels 310 consisting of color sub-pixels 313 and the pixels 310 consisting of white sub-pixels 311 are alternatively disposed. In this embodiment, such configuration can have not only the advantage of simplifying the driving circuit design but also the advantage of increasing the distribution area of the white sub-pixels 311 to enhance the transparency and the see-through effect of the display apparatus.

Although the preferred embodiments of present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. A display apparatus, comprising:
a display panel having a display area, a plurality of white sub-pixels and a plurality of color sub-pixels mixedly arranged in the display area; and
a light source module disposed on a backside of the display panel, the light source module generating light for displaying an image on the display area, wherein after the light passes through the display area, the white sub-pixels has a first brightness value, the color sub-pixels has a second brightness value, and the first brightness value is smaller than the second brightness value.

2. The display apparatus of claim 1, wherein the light generated corresponding to the white sub-pixels by the light source module is less than the light generated corresponding to the color sub-pixels.

3. The display apparatus of claim 2, wherein the light source module comprises a light guide plate; the light guide plate is disposed on the backside of the display panel; the light guide plate is formed with a plurality of light-output microstructures on a bottom face away from the display panel; the light-output microstructures are disposed only at locations outside a projection area of the white sub-pixels on the bottom face.

4. The display apparatus of claim 2, wherein the light source module comprises a plurality of direct-lighting light sources facing the backside of the display panel and generating light into the display area; the direct-lighting light sources are disposed only at locations outside a projection area of the white sub-pixels on the bottom face.

5. The display apparatus of claim 4, wherein the direct-lighting light sources has a lighting field angle less than 120 degrees.

6. The display apparatus of claim 1, wherein the display area is divided into a plurality of pixels; each of the pixels consists of a plurality of the color sub-pixels of different colors and at least one of the white sub-pixels; in a same pixel, the at least one white sub-pixel is disposed on a same side of the color sub-pixels.

7. The display apparatus of claim 6, wherein in the same pixel, the color sub-pixels are disposed along a first direction, the at least one white sub-pixel is also disposed along the first direction and arranged with the color sub-pixels.

8. The display apparatus of claim 6, wherein in the same pixel, the color sub-pixels are disposed along a first direction, the at least one white sub-pixel is disposed parallel to the first direction and on one side of the color sub-pixels.

9. The display apparatus of claim 1, wherein the display area is divided into a plurality of pixels; each of the pixels consists of a plurality of the color sub-pixels of different colors or a plurality of the white sub-pixels; the pixels consisting of the color sub-pixels and the pixels consisting of the white sub-pixels are alternatively disposed.

10. The display apparatus of claim 1, further comprising a switchable diffusion film disposed between the display panel and the light source module, wherein the switchable diffusion film is selectively switched between a diffusion mode and a transmission mode.

11. The display apparatus of claim 1, further comprising a control module controlling the display panel and the light source module, wherein when set at a transparent mode, the control module controls the white sub-pixels allowing light to transmit therethrough and controls the color sub-pixels reducing light generated therefrom.

12. The display apparatus of claim 11, wherein when set at the transparent mode, the control module controls the light source module turning off light.

13. The display apparatus of claim 11, wherein when set at a display mode, the control module increases the second brightness value.

14. The display apparatus of claim 13, further comprising a switchable diffusion film disposed between the display panel and the light source module, wherein when set at the transparent mode, a part of the switchable diffusion film corresponding to the white sub-pixels is switched to a transmission mode; when set at the display mode, a part of the switchable diffusion corresponding to the color sub-pixels is switched to a diffusion mode.

15. A display apparatus, comprising:
a display panel having a display area, a plurality of white sub-pixels and a plurality of color sub-pixels mixedly arranged in the display area; and
a light source module disposed or formed on a backside of the display panel, the light source module generating light for displaying an image on the display area, wherein a part of the light source module corresponding to the white sub-pixels is at least partially transparent;
a control module controlling the display panel and the light source module, wherein when set at a transparent mode, the control module controls the white sub-pixels allowing light to transmit therethrough and simultaneously controls the color sub-pixels reducing a display brightness thereof.

16. The display apparatus of claim 15, wherein the light generated corresponding to the white sub-pixels by the light source module is far less than the light generated corresponding to the color sub-pixels by the light source module.

17. The display apparatus of claim 15, wherein the light source module comprises a light guide plate; the light guide plate is disposed on the backside of the display panel; the light guide plate is formed with a plurality of light-output microstructures on a bottom face away from the display panel; the light-output microstructures are disposed only at locations outside a projection area of the white sub-pixels on the bottom face.

18. The display apparatus of claim 15, wherein the light source module comprises a plurality of direct-lighting light sources facing the backside of the display panel and generating light into the display area; the direct-lighting light sources are disposed only at locations outside a projection area of the white sub-pixels on the bottom face.

19. The display apparatus of claim 18, wherein the direct-lighting light sources has a lighting field angle less than 120 degrees.

20. The display apparatus of claim 15, wherein the display area is divided into a plurality of pixels; each of the pixels consists of a plurality of the color sub-pixels of different colors and at least one of the white sub-pixels; in a same pixel, the at least one white sub-pixel is on a same side of the color sub-pixels.

21. The display apparatus of claim 19, wherein in the same pixel, the color sub-pixels are disposed along a first direction, the at least one white sub-pixel is also disposed along the first direction and arranged with the color sub-pixels.

22. The display apparatus of claim 19, wherein in the same pixel, the color sub-pixels are disposed along a first direction, the at least one white sub-pixel is disposed parallel to the first direction and on one side of the color sub-pixels.

23. The display apparatus of claim 15, wherein the display area is divided into a plurality of pixels; each of the pixels consists of a plurality of the color sub-pixels of different colors or a plurality of the white sub-pixels; the pixels consisting of the color sub-pixels and the pixels consisting of the white sub-pixels are alternatively disposed.

24. The display apparatus of claim 15, further comprising a switchable diffusion film disposed between the display panel and the light source module, wherein the switchable diffusion film is selectively switched between a diffusion mode and a transmission mode; when set at the transparent mode, the switchable diffusion film is switched to the transmission mode.

25. A display apparatus, comprising:
a self-lighting display module having a plurality of white sub-pixels and a plurality of color sub-pixels, wherein the white sub-pixels are at least partially transparent; the color sub-pixels and the white sub-pixels are mixedly arranged; and
a control module controlling the white sub-pixels and the color sub-pixels,
wherein when the control module is set at a transparent mode, the control module controls to reduce light emitting from the color sub-pixels and allow a part of an ambient light to pass through the white sub-pixels.

26. The display apparatus of claim 25, wherein when set at a display mode, the control module controls light generated at the white sub-pixels being far less than light generated at the color sub-pixels.
